(19) United States
(12) Patent Application Publication
(10) Pub. No.: US 2012/0222466 A1
(43) Pub. Date: Sep. 6, 2012

(54) DEVICE

(76) Inventors: Peter Lawrence Bailey, Bebington (GB); Daniel Brady, Old Windsor (GB); Matthew Daniel Chandler, Cambridge (GB); Nicholas John Collier, Burwell (GB); Thomas John Hector Copeland, Cambridge (GB); Stephen Anthony Sayers, Aston Clinton (GB)

(21) Appl. No.: 13/505,836

(22) PCT Filed: Nov. 22, 2010
(86) PCT No.: PCT/EP2010/067906

§ 371 Date: May 3, 2012

(30) Foreign Application Priority Data
Nov. 24, 2009 (EP) 09176899.4

(51) Int. Cl. G01N 19/02

(52) U.S. Cl. 73/9

(57) ABSTRACT

Device for measuring hair damage comprising a handle (2) and a shaft (3) and a mandrel, a clip (4) and a feedback indicator, wherein the mandrel and clip are attachable to the shaft and the mandrel is drivable along the length of the shaft to measure the friction of a lock of hair which is wound around the mandrel and back onto itself and held in place by the clip such that fibres in the lock of hair are rubbed against themselves along the general direction of the hair fibres and use of such a device.

The present invention relates to a device for measuring hair damage. Despite the prior art there remains the need for devices for measuring hair damage.

Accordingly, and in a first aspect, the present invention provides a device according to claim 1.

Preferably, the clip comprises a pair of opposing tongues pivotally attached to each other.

Preferably, the tongues are maintained in a closed position by a spring. Preferably, the tongues comprise an overhang which extends beyond the pivot and so provides a means for opening the clip against the closing pressure of the spring.

Preferably, the mandrel and the clip are attached to one another such that a subject's hair may be wound around the mandrel and maintained in place by the clip. Preferably, the mandrel is attached to the clip at one end only. The mandrel and clip combination thus provide a gap between mandrel and tongues to allow the hair to be wrapped around the mandrel when the clip is opened.

Preferably, the mandrel comprises a groove. Such a groove assists to provide an aligned portion of hair thus providing more accurate friction measurement. Preferably, the mandrel comprises a series of grooves for maintaining hair aligned and on the mandrel during use.

Preferably, the device comprises means for measuring friction between the superimposed hair fibres. An example of such a means is a load cell. Preferably, the device comprises a handle and a shaft, the shaft having a handle end and a head end, the head end being placed against the head during use to maintain the relative position of the device during use.

Preferably, the mandrel is moved along the shaft when measuring friction between the hair fibres as they are passed over each other. Preferably, the device comprises a motor for automatically moving the mandrel clip along the shaft at a stead rate. This provides a calibrated measuring capability.

Preferably, the mandrel and clip is attached to the device by a magnet. Preferably, the mandrel is attached directly to a trolley on the device.

Preferably, the trolley is drivable along the shaft on the device. During use, the trolley is driven from a head end of the shaft to a handle end of the shaft by a motor. Preferably, the means for measuring friction measures the force required to drive the trolley from the head end of the shaft to the handle end of the shaft. This force is then indicated to the user. During use, the subject's hair is wound around the mandrel and clipped into place by the clip such that hair passes through the clip, around the mandrel and then back through the clip again. The mandrel and clip are then attached to the trolley ready for use.

The device according to the invention is thus able to provide a measure of the condition of the hair fibres by rubbing them over each other and measuring the force required to do this over a set distance. When the hair fibres are in good condition they are smoother and rub over each other more easily thus requiring less force to pass over one another. When the hair fibres are in a poor condition they are less easily rubbed over one another and so require more force.

Accordingly, the device is able to inform the user of the condition of their hair, particularly with regard to fibre damage.

Preferably, the device comprises a power supply. Preferably, such a power supply is rechargeable.

In use the mandrel and clip are attached to one another and are preferably detached from the remainder of the device. The clip is opened and the subject's hair is placed between the mandrel and the clip and then wound around the mandrel such that the hair is passed back towards the hair root, and head. The clip is then closed. The mandrel and clip are then attached to a trolley on the device. The trolley is attached to a drive shaft and, when activated, is driven down the shaft away from the subject's head. Through this process the user's hair is passed through the closed clip and around the mandrel and back through the clip. Accordingly, the hair is passed over itself and so hair travelling in one direction is pressed against hair moving in the opposite direction by the closed clip. Once the trolley reaches the handle end of the shaft a reading is provided on the feedback indicator.

In a second aspect there is provided a method for determining the state of a user's hair by drawing the hair fibres against one another and along the general length of the hair and measuring the friction. Preferably, a lock of hair is folded over itself and drawn along its own length such that the hair towards the tip is drawn backwards over the hair towards the scalp.

An embodiment of the device is further described with reference to the following non-limiting figures in which:

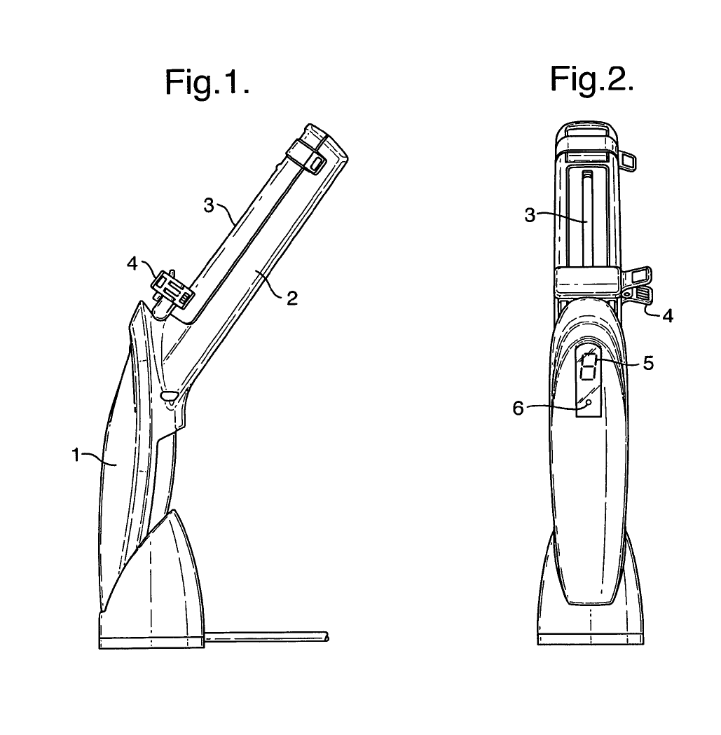

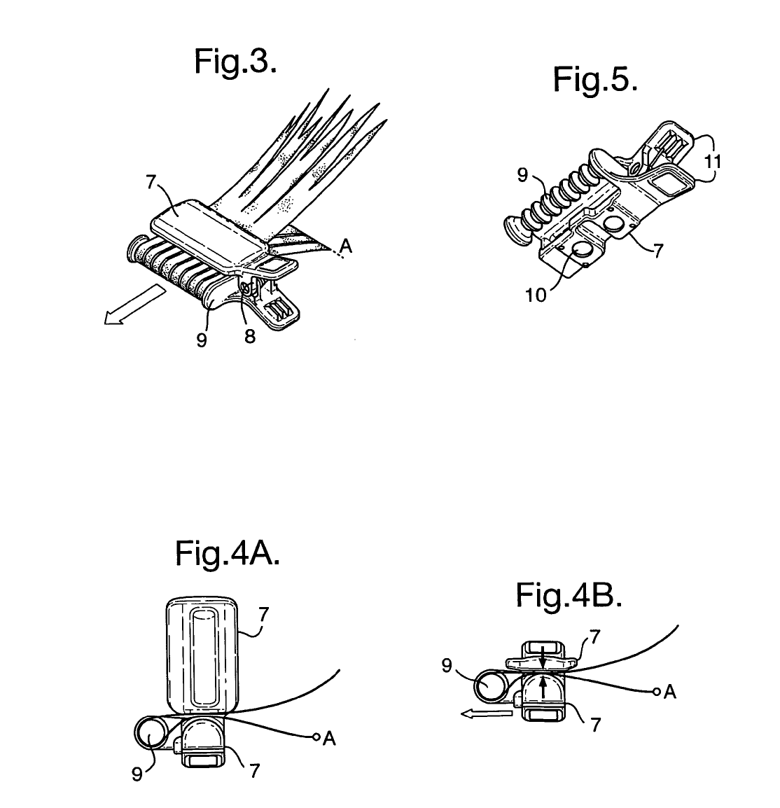

FIG. 1 is a side elevation of a device; FIG. 2 is a front elevation of the same device; FIG. 3 is an isometric view of the mandrel; FIGS. 4a and 4b are the same view of the clip; and FIG. 5 is a view of the underside of the mandrel clip.

In FIG. 1 is a side view of a device with a battery housing 1 and a handle 2. The handle has a causeway 3 along which travels a motorized mandrel clip 4. In use, the subject's hair is passed under the clip 4 and around the mandrel so that the hair tips are folded back towards the hair root. The device also comprises a load cell (not shown) to measure the force required to pull the mandrel clip 4 along the causeway.

The force measured is indicated on the LCD display 5 on the housing. Display 6 indicates that the device is turned on.

FIG. 2 is a front elevation of the device illustrated in FIG. 1.

FIG. 3 is a close up view of the mandrel clip seen in FIGS. 1 and 2. The mandrel clip comprises a clip which is in the form of a pair of opposing tongues 7 (only one shown) which are pressed together and maintained together by a spring (not shown) at their pivot 8. The mandrel clip also comprises a mandrel 9 around which hair is wrapped back on itself.

FIG. 4a shows the clip in an open configuration and FIG. 4b shows the same clip in a closed configuration. In each figure can be seen the mandrel 9 around which hair is wound such that it passes back onto itself towards the root A. The clip is closed and the mandrel is passed along the hair fibres away from the root so that the hair from the tip is passed back over the hair from the root.

FIG. 5 shows the mandrel 9 and the bottom of one of the tongues 7. The clip is openable by squeezing the flanges 11 towards one another. The mandrel has a pair of magnets 10 by which the mandrel is attachable to the remainder of the device.

1. Device for measuring hair damage comprising a handle and a shaft and a mandrel, a clip and a feedback indicator, wherein the mandrel and clip are attachable to the shaft and the mandrel is drivable along the length of the shaft to measure the friction of a lock of hair which is wound around the mandrel and back onto itself and held in place by the clip such that fibres in the lock of hair are rubbed against themselves along the general direction of the hair fibres.

2. Device according to claim 1 wherein the clip comprises a pair of opposing tongues pivotally attached to each other.

3. Device according to claim 2 wherein the tongues are maintained in a closed position by a deformable spring.

4. Device according to claim 1 wherein the mandrel and the clip are attached to one another such that a subject's hair may be wound around the mandrel and maintained in place by the clip.

5. Device according to claim 1 wherein the mandrel comprises a groove.

6. Device according to claim 1 comprising a load cell for measuring the force required to pass the hair fibres along one

7. Device according to claim 1 wherein the mandrel is attached at one end to the clip.

8. Device according to claim 1 where the mandrel and clip are attached to a trolley on the device.

9. Device according to claim 8 wherein the trolley is located on a drive shaft.

10. Device according to claim 8 wherein the mandrel and clip is attachable to the trolley by magnetic means.

11. Use of a device according to claim 1 for measuring the state of health of a user's hair.
